(19) United States
(12) Patent Application Publication
(10) Pub. No.: US 2006/0225941 A1
(43) Pub. Date: Oct. 12, 2006

(54) Compressed air powered vehicle

(76) Inventor: William Jay Cole, Elkhart, IN (US)

Correspondence Address: GLOBAL PATENTS, Suite 120, 838 West Long Lake Rd, Bloomfield Hills, MI, 48302, US

(21) Appl. No.: 11/103,995

(22) Filed: Apr. 11, 2005

(51) Int. Cl. B60K 3/00

(52) U.S. Cl. 180/302

(57) ABSTRACT

A compressed air powered vehicle is disclosed. The vehicle includes a vehicle chassis having wheels. An electric drive motor drivingly engages at least one of the wheels. An electric generator is electrically connected to the electric drive motor, and an air motor drivingly engaging the electric generator. A compressed air source is pneumatically connected to the air motor, and an air compressor is provided on the chassis and pneumatically connected to the compressed air source to replenish compressed air in the compressed air tanks as needed.

### FIELD OF THE INVENTION

The present invention relates to automobiles powered by electricity generated by compressed air. More particularly, the present invention relates to a compressed air powered vehicle which is environmentally-friendly and fuel efficient.

### BACKGROUND OF THE INVENTION

In recent years, considerable research effort has been made to develop alternative sources of fuel for automobiles. This is due both to the decreasing oil supply worldwide and the increasing levels of pollution which internal combustion engines cause. Much of the research has focused on the use of electricity as an alternative to gasoline as a fuel for automobiles. Unlike gasoline, electricity can be generated as needed for use and also does not emit pollutant byproducts which are harmful to the environment.

Therefore, an electric vehicle is needed which includes an on-board electrical generator to generate electricity for powering of the vehicle.

### SUMMARY OF THE INVENTION

The present invention is generally directed to a compressed air powered vehicle. The vehicle includes a vehicle chassis having wheels. An electric drive motor drivingly engages at least one of the wheels. An electric generator is electrically connected to the electric drive motor. An air motor drivingly engaging the electric generator. A compressed air source is pneumatically connected to the air motor, and an air compressor is provided on the chassis and pneumatically connected to the compressed air source to replenish compressed air in the compressed air tanks as needed.

### BRIEF DESCRIPTION OF THE DRAWINGS

The invention will now be described, by way of example, with reference to the accompanying drawings, in which:

FIG. 1 is a rear perspective view of an illustrative embodiment of the compressed air powered vehicle of the present invention;

FIG. 2 is a side view of a typical on-board air compressor and compressor motor used to fill compressed air tanks of the compressed air powered vehicle;

FIG. 3 is a top view of a transmission and an electric motor coupled to the transmission of the compressed air powered vehicle;

FIG. 4 is a side view of an electric generator and a compressed air motor coupled to the electric generator for generating electrical power from compressed air in operation of the compressed air powered vehicle;

FIG. 5 is a side view of multiple compressed air tanks, a tank base supporting the tanks and an air delivery manifold connected to the tanks, further illustrating the lower ends of the tanks and the tank base in cross-section and an air supply conduit extending through the tank base for delivering air to the compressed air tanks; and

FIG. 6 is a schematic diagram of an illustrative control system for the compressed air powered vehicle.

### DETAILED DESCRIPTION OF THE INVENTION

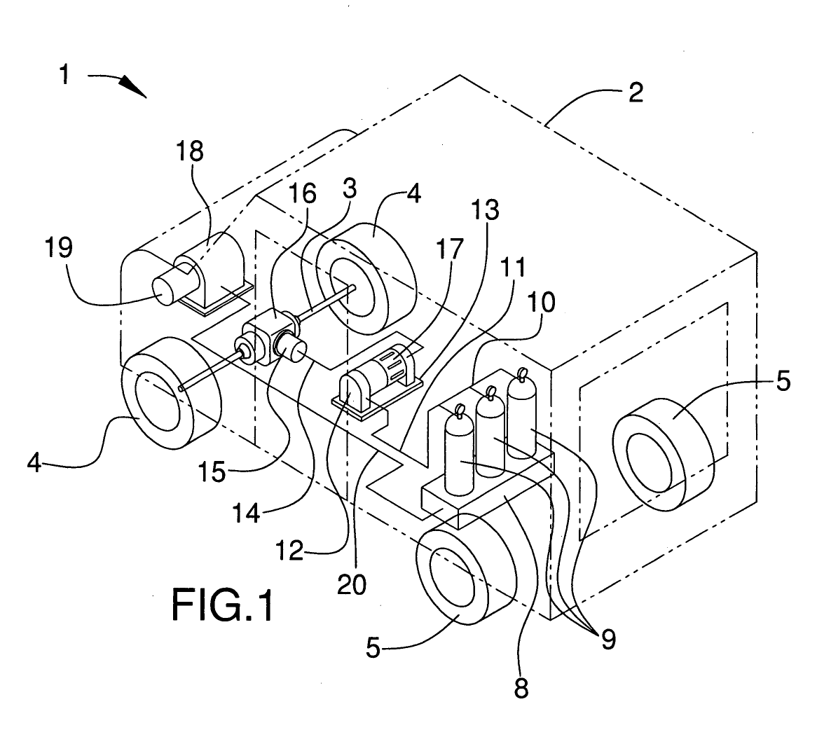

Referring initially to FIGS. 1-5, an illustrative embodiment of the compressed air powered vehicle, hereinafter vehicle, of the present invention is generally indicated by reference numeral 1. The vehicle 1 includes a vehicle frame (not shown) which supports a vehicle chassis 2. When used herein, “chassis” shall be construed to mean either the vehicle chassis 2 or vehicle frame. The vehicle chassis 2 may be the size and configuration of a delivery-type vehicle, such as a mail delivery vehicle, for example, as shown. Alternatively, the chassis 2 may have any desired shape which is consistent with the use requirements of the vehicle 1. The vehicle 1 further includes a front axle 3 which is provided at the front end of the vehicle frame and on which is mounted a pair of front wheels 4. A rear axle (not shown) is provided at the rear end of the vehicle frame, and a pair of rear wheels 5 is provided on the rear axle.

A tank base 8 is provided in the vehicle chassis 2, typically toward the rear portion of the vehicle 1. Multiple, adjacent compressed air tanks 9 are supported in an upright position on the tank base 8. In FIG. 1, three compressed air tanks 9 are shown, although the vehicle 1 may include any desired number of the compressed air tanks 9. Preferably, one of the compressed air tanks 9 is used to generate electricity for propulsion of the vehicle 1 while the remaining two compressed air tanks 9 are used as spare tanks.

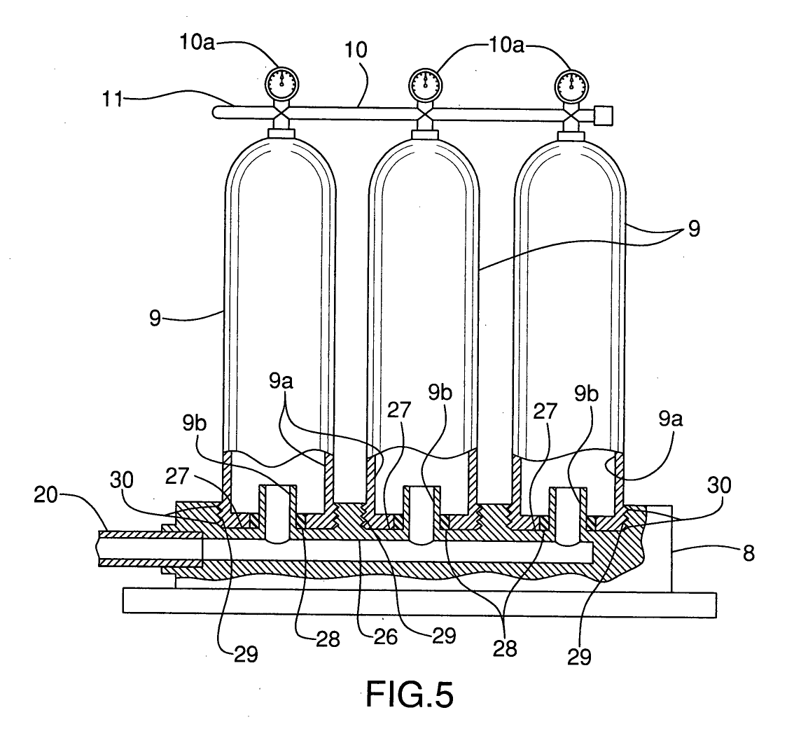

As shown in FIG. 5, each tank 9 has a tank interior 9a in which compressed air is stored during operation of the vehicle 1. Multiple tank cavities 27 may be provided in the upper surface of the tank base 8. Interior cavity threads 29 extend, from the interior surface of each tank cavity 27. Exterior tank threads 30 are provided on the exterior surface of each compressed air tank 9 for threadably engaging the cavity threads 29 in a corresponding tank cavity 27. Accordingly, the meshing tank threads 30 and cavity threads 29 removably secure each compressed air tank 9 in the corresponding tank cavity 27.

An air supply conduit 26 extends through the tank base 8. Multiple tank inlets 9b establish pneumatic communication between the air supply conduit 26 and the tank interiors 9a of the respective compressed air tanks 9. A resilient tank seal 28 may provide an airtight seal between each tank cavity 27 and the corresponding tank inlet 9b. An air delivery line 20 is pneumatically connected to the air supply conduit 26 for purposes which will be hereinafter described.

A manifold 10 is pneumatically connected to the compressed air tanks 9. Pressure gauges 10a may be pneumatically connected to the respective compressed air tanks 9 at the manifold 10 to indicate the pressure of compressed air contained in the respective compressed air tanks 9. An air delivery line 11, the purpose of which will be hereinafter described, extends from the manifold 10.

As shown in FIG. 1, a compressed air motor 12, which may be supported on the vehicle frame (not shown) or chassis 2 by a motor support 13, is pneumatically connected to the air delivery line 11 which is connected to the manifold 10 of the compressed air tanks 9. As shown in FIG. 4, an electric generator 17 is coupled to the compressed air motor 12 in such a manner that the electric generator 17 generates electricity responsive to operation of the compressed air motor 12. As shown in FIG. 3, a transmission 16 is coupled to the front axle 3. An electric drive motor 15 engages the transmission 16 for rotating the front axle 3 in a selected forward or reverse direction. An electric connector 14, such as suitable wiring, electrically connects the electrical output of the electric generator 17 to the electric drive motor 15. Accordingly, the electric drive motor 15 is supplied with electrical power from the electric generator 17 through the electrical connector 14 and is capable of rotating the front axle 3 to propel the vehicle 1 in the selected forward or reverse direction through the transmission 16.

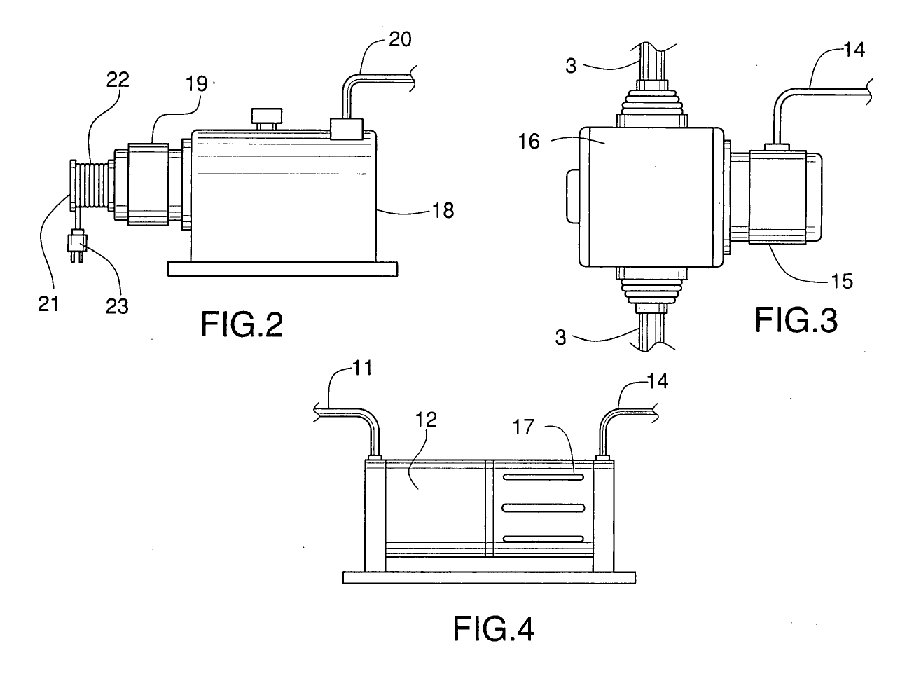

An air compressor 18 is provided in the vehicle 1, typically at the front end portion of the vehicle frame (not shown) or chassis 2. As shown in FIG. 2, the air compressor 18 includes a compressor motor 19 which is pneumatically connected to the air supply conduit 26 (FIG. 5) through the air delivery line 20. A retractable cord reel 21 is typically rotatably mounted on the compressor motor 19. An electrical cord 22, which is electrically connected to the compressor motor 19, is wound on the retractable cord reel 21. A cord plug 23 is provided on the electrical cord 22 to facilitate plugging the electrical cord 22 into a standard, 120-volt household electrical outlet (not shown). Accordingly, when the vehicle 1 is stationary, the cord plug 23 can be plugged into a standard 120-volt electrical outlet to supply electrical power to the air compressor 18. The air compressor 18 is operated to force air through the air delivery line 20 and into the respective compressed air tanks 9 when it is necessary to replace compressed air in the compressed air tanks 9.

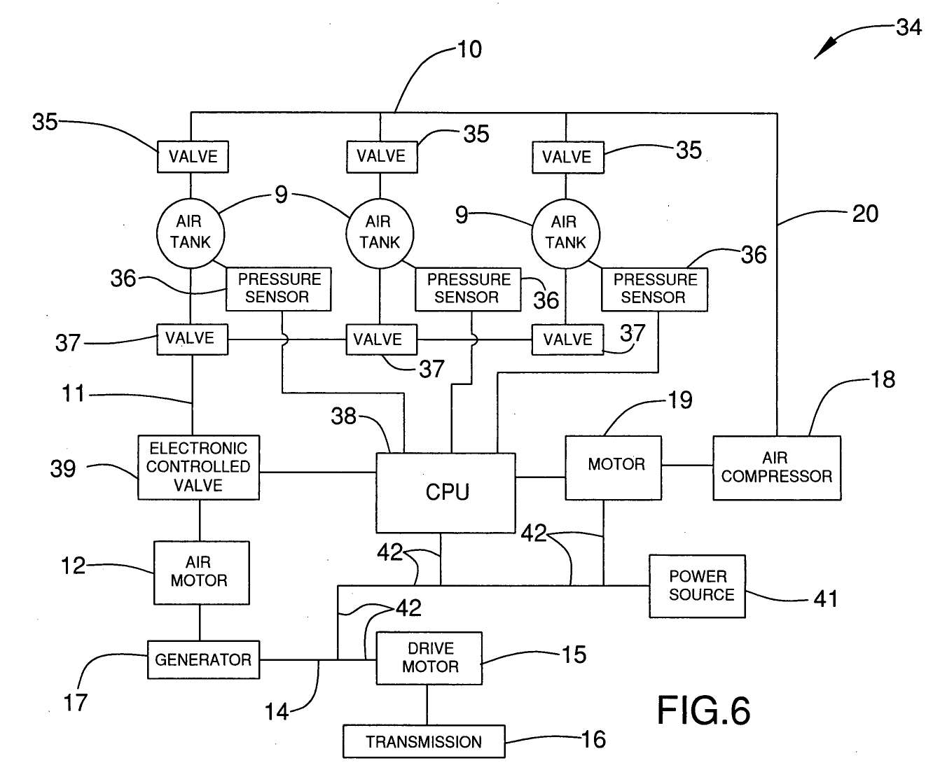

An illustrative control system 34 for the vehicle 1 is shown in FIG. 6. The control system 34 typically includes a power source 41 which is connected to the compressor motor 19 and the drive motor 15 through power source wiring 42. A central processing unit (CPU) 38 is further connected to the power source 41 through power source wiring 42. The CPU 38 is connected to the compressed air tanks 9 through respective pressure sensors 36. Multiple valves 35 are interposed between the respective compressed air tanks 9 and the manifold 10. The CPU 38 is further connected to the compressor motor 19 and to an electronic controlled valve 39. The compressed air motor 12 is provided between the electronic controlled valve 39 and the electric generator 17. Multiple valves 37 are interposed between the respective compressed air tanks 9 and the electronic controlled valve 39.

In operation of the vehicle 1, compressed air is delivered from a selected one of the compressed air tanks 9 and through the valve 37 and air delivery line 11 and to the air motor 12. Flow of air through the air delivery line 11 is controlled by the CPU 38 via the electronic controlled valve 39. The compressed air drives the air motor 12, which causes the generator 17 to generate electrical power. The generated electrical power is transmitted to the electric drive motor 15 through the electrical connector 14. The electric drive motor 15, in turn, rotates the axle 3 and the front wheels 4 in the forward or reverse direction depending on the position of the transmission 16.

As compressed air is distributed from the compressed air tank 9, through the air delivery line 11 and to the air motor 12, the pressure sensor 36 constantly measures the air pressure inside the air tank 9 and transmits this information to the CPU 38. The CPU 38, in turn, may transmit this information to a pressure gauge (not shown) provided on the dashboard (not shown) or elsewhere in the chassis 2. Additionally, the pressures inside the compressed air tanks 9 are displayed on the respective pressure gauges 10a (FIG. 5). When is necessary to replenish the compressed air inside the compressed air tank 9, the vehicle 1 is parked at a location at which there exists a standard 120-volt electrical outlet (not shown). Therefore, the electrical cord 22 is unwound from the retractable cord reel 21 (FIG. 2) and the cord plug 23 is plugged into the outlet. This powers the compressor motor 19 of the air compressor 18, thereby facilitating replenishment of compressed air in the compressed air tank 9 from the air compressor 18 and through the air delivery line 20. Simultaneously, the pressure sensors 36 (FIG. 6) continually measure the rising air pressure inside the compressed air tank 9 and transmit this information to the CPU 38. When the pressure inside the compressed air tank 9 reaches a predetermined level, the CPU 38, in turn, automatically terminates operation of the compressor motor 19 to stop further flow of compressed air into the compressed air tank 9. The vehicle 1 is then primed for further propulsion through operation of the electric generator 17 and electric drive motor 15, as was heretofore described.

While the preferred embodiments of the invention have been described above, it will be recognized and understood that various modifications can be made in the invention and the appended claims are intended to cover all such modifications which may fall within the spirit and scope of the invention.

What is claimed is:

1. A compressed air powered vehicle comprising:
a vehicle chassis having wheels;
an electric drive motor drivingly engaging at least one of said wheels;
an electric generator electrically connected to said electric drive motor;
an air motor drivingly engaging said electric generator;
a compressed air source pneumatically connected to said air motor; and
an air compressor carried by said chassis and pneumatically connected to said compressed air source.

2. The compressed air powered vehicle of claim 1 wherein said compressed air source comprises a plurality of compressed air tanks.

3. The compressed air powered vehicle of claim 2 further comprising a tank base and wherein said plurality of compressed air tanks are carried by said tank base.

4. The compressed air powered vehicle of claim 3 further comprising an air supply conduit provided in said tank base and pneumatically connected to said plurality of compressed air tanks and said air compressor.

5. The compressed air powered vehicle of claim 1 further comprising a front axle carried by said frame and wherein said electric drive motor drivingly engages said front axle.

6. The compressed air powered vehicle of claim 5 further comprising a transmission drivingly engaging said front axle and wherein said electric drive motor drivingly engages said transmission.

7. The compressed air powered vehicle of claim 1 wherein said air compressor comprises a compressor motor pneumatically connected to said compressed air source.

8. The compressed air powered vehicle of claim 7 further comprising a retractable cord reel carried by said compressor motor.

9. A compressed air powered vehicle comprising:
a vehicle chassis having wheels;
an electric drive motor drivingly engaging at least one of said wheels;
an electric generator electrically connected to said electric drive motor;
an air motor drivingly engaging said electric generator;
a compressed air source pneumatically connected to said air motor;
an air compressor carried by said chassis and pneumatically connected to said compressed air source; and
a central processing unit connected to said compressed air source and said air compressor.

10. The compressed air powered vehicle of claim 9 wherein said compressed air source comprises a plurality of compressed air tanks.

11. The compressed air powered vehicle of claim 10 further comprising a tank base and wherein said plurality of compressed air tanks are carried by said tank base.

12. The compressed air powered vehicle of claim 11 further comprising an air supply conduit provided in said tank base and pneumatically connected to said plurality of compressed air tanks and said air compressor.

13. The compressed air powered vehicle of claim 9 further comprising a front axle carried by said frame and wherein said electric drive motor drivingly engages said front axle.

14. The compressed air powered vehicle of claim 13 further comprising a transmission drivingly engaging said front axle and wherein said electric drive motor drivingly engages said transmission.

15. The compressed air powered vehicle of claim 9 wherein said air compressor comprises a compressor motor pneumatically connected to said compressed air source.

16. The compressed air powered vehicle of claim 15 further comprising a retractable cord reel carried by said compressor motor.

17. A compressed air powered vehicle comprising:
a vehicle chassis having wheels;
an electric drive motor drivingly engaging at least one of said wheels;
an electric generator electrically connected to said electric drive motor;
an air motor drivingly engaging said electric generator;
a plurality of compressed air tanks pneumatically connected to said air motor;
an air compressor carried by said chassis and pneumatically connected to said plurality of compressed air tanks;
a plurality of pressure sensors connected to said plurality of compressed air tanks, respectively; and
a central processing unit connected to said plurality of pressure sensors and said air compressor.

18. The compressed air powered vehicle of claim 17 further comprising a tank base and wherein said plurality of compressed air tanks are carried by said tank base.

19. The compressed air powered vehicle of claim 18 further comprising an air supply conduit provided in said tank base and pneumatically connected to said plurality of compressed air tanks and said air compressor.

20. The compressed air powered vehicle of claim 18 further comprising a plurality of tank cavities provided in said tank base and wherein said plurality of compressed air tanks are seated in said plurality of tank cavities, respectively.
